(19) United States
(12) Patent Application Publication
(10) Pub. No.: US 2026/0056292 A1
(43) Pub. Date: Feb. 26, 2026

(54) LIDAR AND VEHICLE

(71) Applicant: AUTOX TECH PTE. LTD., SINGAPORE (SG)

(72) Inventors: Jianxiong Xiao, Shenzhen (CN); Qing Deng, Shenzhen (CN); Yizhou Shan, Shenzhen (CN); Yujian Zhong, Shenzhen (CN); Zhuo Li, Shenzhen (CN)

(73) Assignee: AUTOX TECH PTE. LTD., SINGAPORE (SG)

(21) Appl. No.: 19/214,457

(22) Filed: May 21, 2025

(30) Foreign Application Priority Data
Sep. 24, 2024 (CN) 2024113363204

(51) Int. Cl. G01S 7/481; G01S 17/88

(52) U.S. Cl. CPC G01S 7/4813; G01S 7/4817; G01S 17/88

(57) ABSTRACT

A LiDAR and a vehicle are provided. The LiDAR includes a stator and a rotor. The stator, includes a stator bottom shell, and a stator sidewall, the stator bottom shell defining with a liquid cooling pipeline surrounding around the stator sidewall and passing through the stator sidewall to connect to an external cooling device. The rotor is fixed to the stator, including a first circuit board, a rotor bottom shell, and a rotor sidewall. The first circuit board is fixed to the rotor bottom shell. A plurality of first components are arranged at the first circuit board. Each of the plurality of first components is provided with a first heat-conducting layer directly contacting the rotor bottom shell. The rotor bottom shell is provided with a first labyrinth component. The stator bottom shell is provided with a second labyrinth component cooperating with the first one to form a labyrinth structure.

### CROSS REFERENCE TO RELATED APPLICATION

This non-provisional patent application claims priority under 35 U. S. C. §119 from Chinese Patent Application No. 202411336320.4 filed on Sep. 24, 2024, the entire content of which is incorporated herein by reference.

### TECHNICAL FIELD

This application relates to the technical field of LiDAR, particularly to a LiDAR and a vehicle.

### BACKGROUND

As one of the core sensors in autonomous driving systems, a LiDAR offers advantages such as long detection distance, high resolution, and all-weather operation. A mechanical rotating LiDAR can perform 360-degree horizontal field-of-view scanning of the surrounding environment, providing autonomous driving systems with comprehensive environmental information.

Due to measures to enhance perception effect, such as increasing laser power, improving resolution, and increasing a quantity of lasers, the LiDAR may generate excessive heat, necessitating thermal dissipation. Existing thermal dissipation solutions include air cooling and liquid cooling. However, air cooling has low thermal dissipation efficiency and relies heavily on cooling areas. liquid cooling pipelines required for liquid cooling need to be connected to an external cooling device, meaning the liquid cooling pipelines can only be arranged in the stationary stator section, yet most of the functional components of LiDAR are located in a rotating rotor. Therefore, how to dissipate heat from the heat-generating components in a rotor has become a challenge limiting the performance improvement of LiDAR.

### SUMMARY

Disclosed are a LiDAR and a vehicle, achieving thermal dissipation for components on a rotor through a labyrinth structure between a stator and the rotor.

In a first aspect, the LiDAR provided includes the stator and the rotor, the stator includes a stator bottom shell, and a stator sidewall extending around the edge of the stator bottom shell, the stator bottom shell is provided with a liquid cooling pipeline surrounding around an inner wall of the stator sidewall and passing through an outer wall of the stator sidewall to connect to an external cooling device; the rotor is fixed to the stator, including a first circuit board, a rotor bottom shell, and a rotor sidewall extending around the edge of the rotor bottom shell, the first circuit board is fixed to the rotor bottom shell, a plurality of first components are arranged at a side of the first circuit board facing toward the rotor bottom shell, each of the plurality of first components is provided with a first heat-conducting layer directly contacting the rotor bottom shell on a side facing toward the rotor bottom shell; a side of the rotor bottom shell facing away from the first circuit board is provided with a first labyrinth component, a side of the stator bottom shell facing away from the liquid cooling pipeline is provided with a second labyrinth component facing the first labyrinth component, the first labyrinth component and the second labyrinth component cooperate to form a labyrinth structure, with a heat-conducting cavity for filling with thermal grease; the plurality of first components generate a first heat when the LiDAR operating, the first heat is conducted through the first heat-conducting layer to the rotor bottom shell and then to the labyrinth structure, to be conducted through the thermal grease to the stator bottom shell and then to the liquid cooling pipeline.

In a second aspect, the vehicle provided includes a vehicle body, and the LiDAR disposed on the vehicle body, the LiDAR includes the stator and the rotor, the stator includes the stator bottom shell, and the stator sidewall extending around the edge of the stator bottom shell, the stator bottom shell is provided with the liquid cooling pipeline surrounding around the inner wall of the stator sidewall and passing through the outer wall of the stator sidewall to connect to the external cooling device; the rotor is fixed to the stator, including the first circuit board, the rotor bottom shell, and the rotor sidewall extending around the edge of the rotor bottom shell, the first circuit board is fixed to the rotor bottom shell, the plurality of first components are arranged at the side of the first circuit board facing toward the rotor bottom shell, each of the plurality of first components is provided with the first heat-conducting layer directly contacting the rotor bottom shell on the side facing toward the rotor bottom shell; the side of the rotor bottom shell facing away from the first circuit board is provided with the first labyrinth component, the side of the stator bottom shell facing away from the liquid cooling pipeline is provided with the second labyrinth component facing the first labyrinth component, the first labyrinth component and the second labyrinth component cooperate to form the labyrinth structure, with the heat-conducting cavity for filling with thermal grease; the plurality of first components generate the first heat when the LiDAR operating, the first heat is conducted through the first heat-conducting layer to the rotor bottom shell and then to the labyrinth structure, to be conducted through the thermal grease to the stator bottom shell and then to the liquid cooling pipeline.

The LiDAR and vehicle mentioned-above are provided with corresponding labyrinth components on opposite end faces of the stator bottom shell and the rotor bottom shell to form a labyrinth structure with a heat-conducting cavity filled with thermal grease, enable heat-generating components on the first circuit board of the rotor, which generate heat during LiDAR operation, to conduct heat through the labyrinth structure and thermal grease to the stator bottom shell and then to the liquid cooling pipeline arranged on the stator bottom shell, so as to achieve thermal dissipation for the components on the rotor. Meanwhile, components disposed on the circuit board of the stator can similarly conduct heat directly to the liquid cooling pipeline through the stator bottom shell contacted, thereby realizing simultaneous thermal dissipation for components on both the stator and the rotor using a single cold source.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 illustrates a first perspective-view schematic diagram of a LiDAR.

FIG. 2 illustrates a second perspective-view schematic diagram of a LiDAR.

FIG. 3 illustrates a first perspective-view of a stator.

FIG. 4 illustrates a second perspective-view of a stator.

FIG. 5 illustrates a first perspective-view of a rotor.

FIG. 6 illustrates a second perspective-view of a rotor.

FIG. 7 illustrates a first exploded-view schematic diagram of the LiDAR.

FIG. 8 illustrates a second exploded-view schematic diagram of the LiDAR.

FIG. 9 illustrates a cross-sectional view schematic diagram of the LiDAR.

FIG. 10 illustrates a schematic diagram of a vehicle.

The realization of the purpose, functional characteristics and advantages of the disclosure will be further explained by referring to the attached drawings.

### DETAILED DESCRIPTION OF THE EMBODIMENTS

In order to make the purpose, technical solution and advantages of the invention more clearly, the invention is further described in detail in combination with the drawings and embodiments. It is understood that the specific embodiments described herein are used only to explain the invention and are not configured to define it. On the basis of the embodiments in the invention, all other embodiments obtained by ordinary technicians in this field without any creative effort are covered by the protection of the invention.

The terms “first”, “second”, “third”, “fourth”, if any, in the specification, claims and drawings of this application are configured to distinguish similar objects but need not be configured to describe any particular order or sequence of priorities. It should be understood that the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the invention are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the invention.

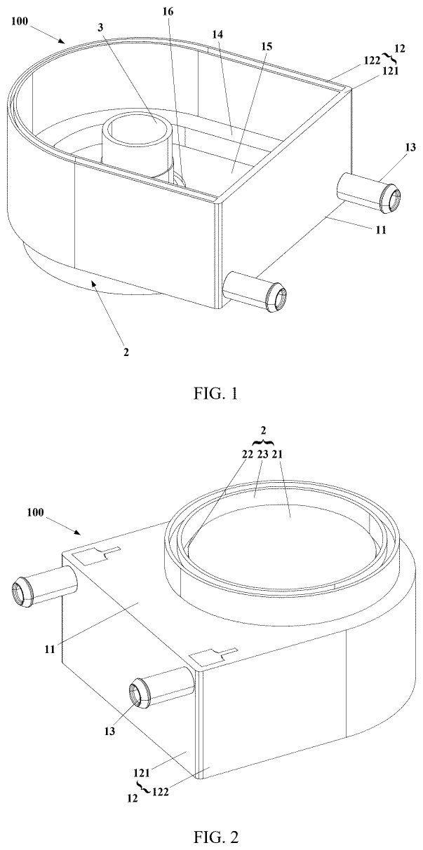

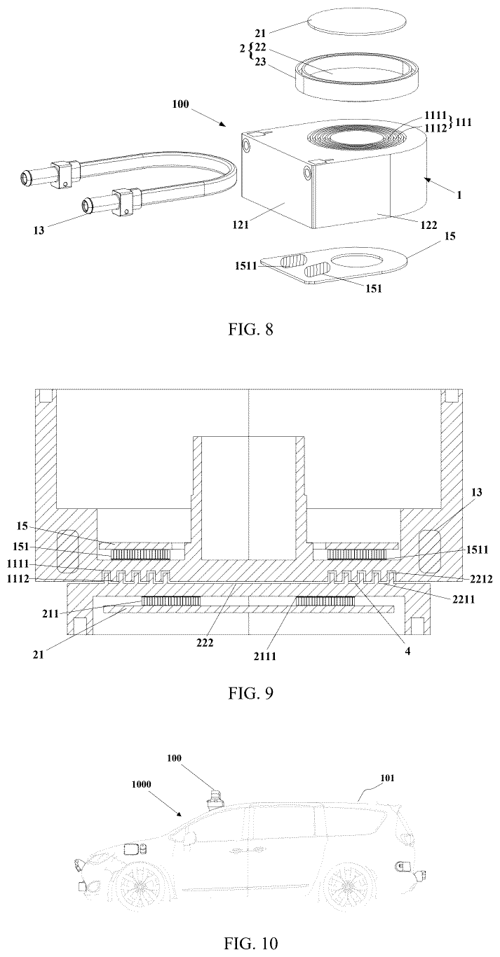

Referring to FIGS. 1-2 and FIGS. 7-8. FIGS. 1-2 illustrate perspective-view schematic diagrams of a LiDAR from different viewpoints. FIGS. 7-8 illustrate exploded-view schematic diagrams of a LiDAR from different viewpoints. The LiDAR 100 provided can dissipate heat from heat-generating components on different modules of the LiDAR 100 simultaneously through a single liquid cooling pipeline 13 provided therein, thereby improving the performance of the LiDAR 100. The specific features of the LiDAR 100 will be elaborated below in conjunction with the drawings.

As shown in FIGS. 1-2, the LiDAR 100 includes a stator 1 and a rotor 2. The stator 1 has thermal conductivity to facilitate the transfer of heat from heat-generating components within the stator 1. The stator 1 includes a stator bottom shell 11 and a stator sidewall 12 extending around the edge of the stator bottom shell 11. The stator bottom shell 11 is provided with the liquid cooling pipeline 13. The liquid cooling pipeline 13 surrounds around an inner wall of the stator sidewall 12, and the stator sidewall 12 is provided with a pipe hole (not shown in the drawings) for the liquid cooling pipeline 13 to pass through, so that the liquid cooling pipeline 13 can pass through an outer wall of the stator sidewall 12 and connect to an external cooling device (not shown in the drawings) to achieve subsequent heat dissipation for the heat-generating components. In the present application, the liquid cooling pipeline 13 serves as a cold source for heat dissipation of the LiDAR 100. The external cooling device includes but is not limited to an external water pipe, a device containing refrigerant, etc., which will not be elaborated here. The specific features of the stator sidewall 12 and the liquid cooling pipeline 13 will be described in detail below.
a plurality of first components being arranged at a side of the first circuit board facing toward the rotor bottom shell, each of the plurality of first components defining with a first heat-conducting layer directly contacting the rotor bottom shell on a side facing toward the rotor bottom shell;

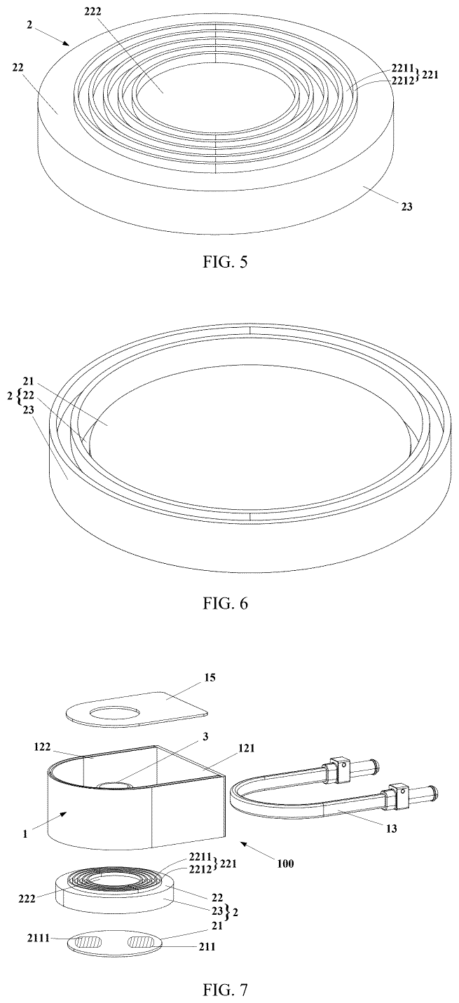

Referring to FIGS. 5-6. The rotor 2 is fixed to the stator 1. The rotor 2 rotates relative to the stator 1 when the LiDAR 100 is in operation, and the rotor 2 possesses thermal conductivity to facilitate heat transfer from heat-generating components within the rotor 2. The rotor 2 includes a first circuit board 21, a rotor bottom shell 22, and a rotor sidewall 23 extending around the edge of the rotor bottom shell 22. The first circuit board 21 is fixed to the rotor bottom shell 22 thought fasteners such as a plurality of screws (not shown in the figures). A side of the first circuit board 21 facing toward the rotor bottom shell 22 is provided with a plurality of first components 211. The plurality of first components 211 are the primary functional components of the LiDAR 100, such as a plurality of data processing units of the LiDAR 100. Each first component 211 has a first heat-conducting layer 2111 on a side of the first circuit board 21 facing toward the rotor bottom shell 22, which is directly contacted with the rotor bottom shell 22. In this application, the first heat-conducting layer 2111 is made of a thermally conductive material, so that the first components 211 that are not directly contacted with the rotor bottom shell 22 can transfer heat to the rotor bottom shell 22 through the first heat-conducting layer 2111 when the first components 211 generate heat, thereby achieving heat dissipation for the first components 211. The first components 211 can also be components with a fixed thermally conductive material on one end face, and when arranged, this end face is ensured to face toward the rotor bottom shell 22.

Referring to FIG. 9. A side of the rotor bottom shell 22 facing away from the first circuit board 21 is provided with a first labyrinth component 221, and a side of the stator bottom shell 11 facing away from the liquid cooling pipeline 13 is provided with a second labyrinth component 111 opposite to the first labyrinth component 221. The first labyrinth component 221 and the second labyrinth component 111 cooperate to form a labyrinth structure. The labyrinth structure is provided with a heat-conducting cavity 4 for filling with thermal grease. The plurality of first components 211 generate a first heat when the LiDAR 100 is in operation. The first heat is conducted to the rotor bottom shell 22 through the first heat-conducting layer 2111 and then to the labyrinth structure, where it is conducted to the stator bottom shell 11 through the thermal grease and then to the liquid cooling pipeline 13, thereby achieving heat dissipation for the first components 211 generating heat within the rotor 2. The specific features of the first labyrinth component 221 and the second labyrinth component 111 will be elaborated on below.

In the above embodiment, the structure of the LiDAR 100 is described. The first components 211 generating heat in the rotor 2 of the LiDAR 100 can achieve heat dissipation through the labyrinth structure. The specific features of the stator sidewall 12 and the liquid cooling pipeline 13 will be elaborated on.

the second sidewall is connected to the first sidewall on both sides along the direction of penetration of the liquid cooling pipeline, and provided with a certain curvature, the liquid cooling pipeline surrounds around an inner wall of the second sidewall, and passes through an outer wall of the first sidewall.

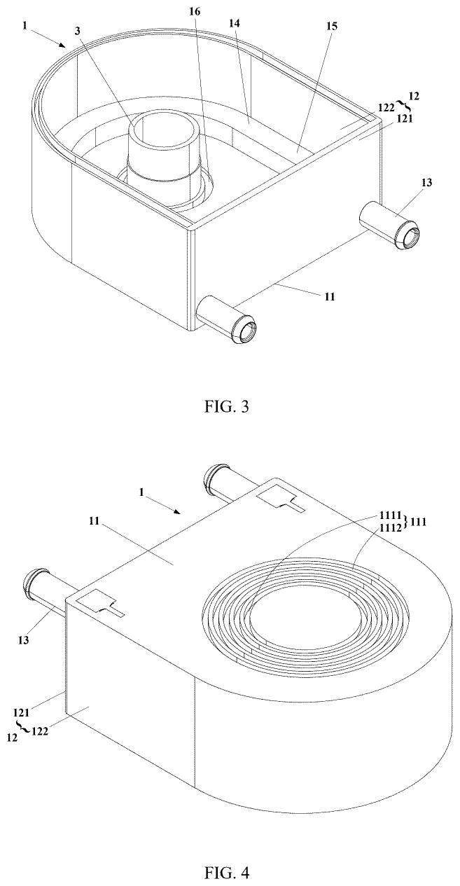

Referring to FIGS. 3-4. The stator sidewall 12 includes a first sidewall 121 and a second sidewall 122. The second sidewall 122 is connected to both sides of the first sidewall 121 along the direction of penetration of the liquid cooling pipeline 13. The second sidewall 122 has a certain curvature when extending along this insertion direction. The liquid cooling pipeline 13 surrounds around an inner wall of the second sidewall 122 and passes through an outer wall of the first sidewall 121, i.e., the pipe hole is located on the first sidewall 121.

Furthermore, the stator 1 also includes a pipeline cavity 14. The pipeline cavity 14 is configured to accommodate the liquid cooling pipeline 13. The pipeline cavity 14 is located in the stator bottom shell 11 and surrounds around the inner wall of the second sidewall 122. Both ends of the pipeline cavity 14 are located at the first sidewall 121, allowing the liquid cooling pipeline 13 to pass through the outer wall of the first sidewall 121.

In this embodiment, the stator 1 also includes a second circuit board 15. The second circuit board 15 is fixed to the stator bottom shell 11 thought fasteners such as a plurality of screws. The edge of the second circuit board 15 surrounds around a side of the pipeline cavity 14 opposite to the stator sidewall 12. The edge of the second circuit board 15 can be directly contacted with the side of the pipeline cavity 14 facing away from the stator sidewall 12, or not directly contacted. A side of the second circuit board 15 facing toward the stator bottom shell 11 is provided with a plurality of second components 151. The plurality of second components 151 are the secondary functional components of the LiDAR 100, such as a plurality of data receiving units of the LiDAR 100. Each second component 151 is provided with a second heat-conducting layer 1511 on a side facing the stator bottom shell 11, which is directly contacted with the stator bottom shell 11. In this application, the second heat-conducting layer 1511 is made of a thermally conductive material, so that the second components 151 that are not directly contacted with the stator bottom shell 11 can transfer heat to the stator bottom shell 11 through the second heat-conducting layer 1511 when the second components 151 generate heat, thereby achieving heat dissipation for the second components 151. In this application, the second components 151 can also be components with a thermally conductive material on one end face, and when arranged, this end face is ensured to face the stator bottom shell 11. Preferably, a quantity of first components 211 is greater than a quantity of second components 151.

In this embodiment, the plurality of second components 151 generate a second heat when the LiDAR 100 is operating. The second heat is conducted through the second heat-conducting layer 1511 to the stator bottom shell 11 and then to the liquid cooling pipeline 13, achieving a heat dissipation effect for the heat-generating components within the stator 1, and further enabling simultaneous heat dissipation for both the stator 1 and the rotor 2 of the LiDAR 100 through a single liquid cooling pipeline 13. Preferably, a magnitude of the first heat is greater than a magnitude of the second heat.

In the above embodiment, the specific characteristics of the stator sidewall 12 and the liquid cooling pipeline 13 are described, and it is explained that the present application allows for simultaneous heat dissipation of both the stator 1 and the rotor 2 of the LiDAR 100 through a single liquid cooling pipeline 13. The specific characteristics of the first labyrinth component 221 and the second labyrinth component 111 will be described in detail.

the first flat portion faces to the second protruding portion, the second flat portion faces to the first protruding portion

Referring to FIG. 9. The first labyrinth component 221 is provided with a plurality of annular first flat portions 2211 and a plurality of annular first protruding portions 2212. The first flat portions 2211 and the first protruding portions 2212 alternate. In the present application, the size, quantity, and other characteristics of the first flat portions 2211 and the first protruding portions 2212 can be adjusted according to the needs of the LiDAR 100, and will not be elaborated upon here. The second labyrinth component 111 is provided with a plurality of annular second flat portions 1111 and a plurality of annular second protruding portions 1112. The second flat portions 1111 and the second protruding portions 1112 alternate. In the present application, the size, quantity, and other characteristics of the second flat portions 1111 and the second protruding portions 1112 can be adjusted according to the needs of the LiDAR 100, and will not be elaborated upon here. The sizes of the first flat portions 2211 and the second flat portions 1111 are equal. The sizes of the first protruding portions 2212 and the second protruding portions 1112 are equal. The first flat portions 2211 face to the second protruding portions 1112, and the second flat portions 1111 face to the first protruding portions 2212, to improve the sealing of the labyrinth structure, reduce the occurrence of thermal grease leakage outside the LiDAR 100, and thereby ensure the heat dissipation efficiency of the rotor 2 of the LiDAR 100.

Preferably, to improve the sealing of the labyrinth structure, a quantity of first flat portions 2211 is equal to a quantity of second protruding portions 1112, a quantity of second flat portions 1111 is equal to a quantity of first protruding portions 2212, and the first flat portions 2211 and second protruding portions 1112, as well as the second flat portions 1111 and first protruding portions 2212, form a corresponding relationship in shape. How the rotor 2 is fixed to the stator 1 and how the rotor 2 achieves rotation when the LiDAR 100 is operating will be further described.

In this embodiment, the stator bottom shell 11 is further provided with a through hole 16. The LiDAR 100 further includes a shaft 3. The shaft 3 is a hollow cylinder that can accommodate one or more bearings (not shown in the figure). In the present application, the bearings can be multiple bearings that have been pre-mechanically connected. The rotor bottom shell 22 is further provided with a rotor through hole (not shown in the figure), so that one end of the bearing is connected to the rotor bottom shell 22 through the rotor through hole. The shaft 3 is mounted on the stator 1, so that the rotor 2 is fixed to the stator 1 by the bearing and rotates relative to the stator 1 when the LiDAR 100 is operating.

Furthermore, a rotor mounting portion 222 is provided on the side of the rotor bottom shell 22 facing away from the first circuit board 21. The second labyrinth component 111 surrounds around the edge of the rotor mounting portion 222. The shaft 3 passes through the through hole 16 and is installed on the rotor mounting portion 222. In the present application, the second circuit board 15 is also mounted on the shaft 3, and the second circuit board 15 has a certain gap with the shaft 3, to allow the rotor 2 to rotate around the shaft 3 when the LiDAR 100 is operating. Preferably, the rotor through hole is located on a side of the rotor mounting portion 222 facing towards the stator bottom shell 11.

In some feasible embodiments, the LiDAR 100 further includes an emitting device (not shown in the figure). The emitting device can be a component that enables the LiDAR 100 to emit laser light outside. The emitting device is fixed between the rotor sidewall 23 and the first circuit board 21, and is directly contacted with both the rotor bottom shell 22 and the rotor sidewall 23, or is directly contacted with one of the rotor bottom shell 22 and the rotor sidewall 23.

Refer to FIG. 10, a schematic diagram of a vehicle is illustrated in FIG. 10.

As shown in FIG. 10, the vehicle 1000 provided includes a vehicle body 101 and the LiDAR 100 disposed on the vehicle body 101. The LiDAR 100 has been described in detail in the mentioned-above embodiment and will not be elaborated upon here.

In the above embodiment, the LiDAR and the vehicle are provided with corresponding labyrinth components on opposite end faces of the stator bottom shell and the rotor bottom shell to form a labyrinth structure with a heat-conducting cavity filled with thermal grease, enable heat-generating components on the first circuit board of the rotor, which generate heat during LiDAR operation, to conduct heat through the labyrinth structure and thermal grease to the stator bottom shell and then to the liquid cooling pipeline arranged on the stator bottom shell, so as to achieve thermal dissipation for the components on the rotor. Meanwhile, components disposed on the circuit board of the stator can similarly conduct heat directly to the liquid cooling pipeline through the stator bottom shell contacted, thereby realizing simultaneous thermal dissipation for components on both the stator and the rotor using a single cold source.

The above disclosed preferred embodiments of the invention are intended only to assist in the elaboration of the invention. The preferred embodiment does not elaborate on all the details and does not limit the invention to a specific embodiment. Obviously, according to the contents of this instruction manual, a lot of amendments and changes can be made. These embodiments are selected and described in detail in this specification for the purpose of better explaining the principle and practical application of the invention, so that the technical personnel in the technical field can better understand and utilize the invention. The invention is limited only by the claims and their full scope and equivalents.

The above are only the preferred embodiments of this invention and do not therefore limit the patent scope of this invention. And equivalent structure or equivalent process transformation made by the specification and the drawings of this invention, either directly or indirectly applied in other related technical fields, shall be similarly included in the patent protection scope of this invention.

1. A LiDAR, the LiDAR comprises:
a stator, comprising a stator bottom shell, and a stator sidewall extending around the edge of the stator bottom shell, the stator bottom shell defining with a liquid cooling pipeline surrounding around an inner wall of the stator sidewall and passing through an outer wall of the stator sidewall to connect to an external cooling device; and
a rotor, fixed to the stator, comprising a first circuit board, a rotor bottom shell, and a rotor sidewall extending around the edge of the rotor bottom shell, the first circuit board fixed to the rotor bottom shell, a plurality of first components being arranged at a side of the first circuit board facing toward the rotor bottom shell, each of the plurality of first components defining with a first heat-conducting layer directly contacting the rotor bottom shell on a side facing toward the rotor bottom shell;
a side of the rotor bottom shell facing away from the first circuit board defining with a first labyrinth component, a side of the stator bottom shell facing away from the liquid cooling pipeline defining with a second labyrinth component facing the first labyrinth component, the first labyrinth component and the second labyrinth component cooperating to form a labyrinth structure, with a heat-conducting cavity for filling with thermal grease; the plurality of first components generating a first heat when the LiDAR operating, the first heat conducted through the first heat-conducting layer to the rotor bottom shell and then to the labyrinth structure, to be conducted through the thermal grease to the stator bottom shell and then to the liquid cooling pipeline.

2. The LiDAR according to claim 1, wherein the stator sidewall comprises a first sidewall and a second sidewall, the second sidewall is connected to the first sidewall on both sides along the direction of penetration of the liquid cooling pipeline, and provided with a certain curvature, the liquid cooling pipeline surrounds around an inner wall of the second sidewall, and passes through an outer wall of the first sidewall.

3. The LiDAR according to claim 2, wherein the stator further comprises a pipeline cavity for accommodating the liquid cooling pipeline, the pipeline cavity is located in the stator bottom shell, and surrounds around the inner wall of the second sidewall, both ends of the pipeline cavity are located at the first sidewall to allow the liquid cooling pipeline to pass through the outer wall of the first sidewall.

4. The LiDAR according to claim 3, wherein the stator further comprises a second circuit board fixed to the stator bottom shell, the edge of the second circuit board surrounds around a side of the pipeline cavity opposite to the stator sidewall, a side of the second circuit board facing toward the stator bottom shell is provided with a plurality of second components, each of the plurality of second components is provided with a second heat-conducting layer on a side facing toward the stator bottom shell directly contacting the stator bottom shell.

5. The LiDAR according to claim 4, wherein the plurality of second components generate a second heat when the LiDAR operating, the second heat is conducted through the second heat-conducting layer to the stator bottom shell and then to the liquid cooling pipeline.

6. The LiDAR according to claim 5, wherein a magnitude of the first heat is greater than a magnitude of the second heat.

7. The LiDAR according to claim 4, wherein the first labyrinth component is provided with a plurality of annular first flat portions and a plurality of annular first protruding portions, the first flat portion and the first protruding portion alternating; the second labyrinth component is provided with a plurality of annular second flat portions and a plurality of annular second protruding portions, the second flat portion and the second protruding portion alternating; the first flat portion faces to the second protruding portion, the second flat portion faces to the first protruding portion.

8. The LiDAR according to claim 6, wherein the stator bottom shell is further provided with a through hole; the LiDAR further comprises a shaft accommodating a bearing, the shaft is mounted on the stator, so as to ensure that the rotor is fixed to the stator by the bearing, and rotates relative to the stator when the LiDAR operating.

9. The LiDAR according to claim 7, wherein a rotor mounting portion is provided on the side of the rotor bottom shell facing away from the first circuit board, the shaft passes through the through hole, and is mounted on the rotor mounting portion, the second labyrinth component surround around the edge of the rotor mounting portion.

10. The LiDAR according to claim 7, wherein the second circuit board is also mounted on the shaft, and has a certain gap with the shaft.

11. A vehicle, the vehicle comprises:
a vehicle body; and
a LiDAR, disposed on the vehicle body, the LiDAR comprises:
a stator, comprising a stator bottom shell, and a stator sidewall extending around the edge of the stator bottom shell, the stator bottom shell defining with a liquid cooling pipeline surrounding around an inner wall of the stator sidewall and passing through an outer wall of the stator sidewall to connect to an external cooling device; and
a rotor, fixed to the stator, comprising a first circuit board, a rotor bottom shell, and a rotor sidewall extending around the edge of the rotor bottom shell, the first circuit board fixed to the rotor bottom shell, a plurality of first components being arranged at a side of the first circuit board facing toward the rotor bottom shell, each of the plurality of first components defining with a first heat-conducting layer directly contacting the rotor bottom shell on a side facing toward the rotor bottom shell;
a side of the rotor bottom shell facing away from the first circuit board defining with a first labyrinth component, a side of the stator bottom shell facing away from the liquid cooling pipeline defining with a second labyrinth component facing the first labyrinth component, the first labyrinth component and the second labyrinth component cooperating to form a labyrinth structure, with a heat-conducting cavity for filling with thermal grease; the plurality of first components generating a first heat when the LiDAR operating, the first heat conducted through the first heat-conducting layer to the rotor bottom shell and then to the labyrinth structure, to be conducted through the thermal grease to the stator bottom shell and then to the liquid cooling pipeline.

12. The vehicle according to claim 11, wherein the stator sidewall comprises a first sidewall and a second sidewall, the second sidewall is connected to the first sidewall on both sides along the direction of penetration of the liquid cooling pipeline, and provided with a certain curvature, the liquid cooling pipeline surrounds around an inner wall of the second sidewall, and passes through an outer wall of the first sidewall.

13. The vehicle according to claim 12, wherein the stator further comprises a pipeline cavity for accommodating the liquid cooling pipeline, the pipeline cavity is located in the stator bottom shell, and surrounds around the inner wall of the second sidewall, both ends of the pipeline cavity are located at the first sidewall to allow the liquid cooling pipeline to pass through the outer wall of the first sidewall.

14. The vehicle according to claim 13, wherein the stator further comprises a second circuit board fixed to the stator bottom shell, the edge of the second circuit board surrounds around a side of the pipeline cavity opposite to the stator sidewall, a side of the second circuit board facing toward the stator bottom shell is provided with a plurality of second components, each of the plurality of second components is provided with a second heat-conducting layer on a side facing toward the stator bottom shell directly contacting the stator bottom shell.

15. The vehicle according to claim 14, wherein the plurality of second components generate a second heat when the LiDAR operating, the second heat is conducted through the second heat-conducting layer to the stator bottom shell and then to the liquid cooling pipeline.

16. The vehicle according to claim 15, wherein a magnitude of the first heat is greater than a magnitude of the second heat.

17. The vehicle according to claim 14, wherein the first labyrinth component is provided with a plurality of annular first flat portions and a plurality of annular first protruding portions, the first flat portion and the first protruding portion alternating; the second labyrinth component is provided with a plurality of annular second flat portions and a plurality of annular second protruding portions, the second flat portion and the second protruding portion alternating; the first flat portion faces to the second protruding portion, the second flat portion faces to the first protruding portion.

18. The vehicle according to claim 16, wherein the stator bottom shell is further provided with a through hole; the LiDAR further comprises a shaft accommodating a bearing, the shaft is mounted on the stator, so as to ensure that the rotor is fixed to the stator by the bearing, and rotates relative to the stator when the LiDAR operating.

19. The vehicle according to claim 17, wherein a rotor mounting portion is provided on the side of the rotor bottom shell facing away from the first circuit board, the shaft passes through the through hole, and is mounted on the rotor mounting portion, the second labyrinth component surround around the edge of the rotor mounting portion.

20. The vehicle according to claim 17, wherein the second circuit board is also mounted on the shaft, and has a certain gap with the shaft.
